(19) United States
(12) Patent Application Publication
(10) Pub. No.: US 2026/0302110 A1
(43) Pub. Date: Oct. 1, 2026

(54) SPRING ELEMENT FOR A TEMPERATURE-DEPENDENT SWITCH, TEMPERATURE-DEPENDENT SWITCH AND METHOD OF MANUFACTURING THE SPRING ELEMENT

(71) Applicant: Marcel P. Hofsaess, Steintahleben (DE)

(72) Inventor: Marcel P. Hofsaess, Steintahleben (DE)

(21) Appl. No.: 19/574,559

(22) Filed: Mar. 23, 2026

(30) Foreign Application Priority Data
Mar. 26, 2025 (DE) 10 2025 111 652.0

(51) Int. Cl. H01H 37/52; H01H 37/04

(52) U.S. Cl. CPC H01H 37/52; H01H 37/04

(57) ABSTRACT

A spring element for a temperature-dependent switching mechanism of a temperature-dependent switch. The spring element is made of an electrically conductive material, in particular metal, and has a central portion whose upper side is convex and whose lower side is concave. Furthermore, the spring element has a plurality of support portions which are distributed in a circumferential direction and each extends inwardly from an outer edge of the central portion inwards towards a central axis of the spring element in such a way that a first side of the support portions faces the underside of the central portion.

### CROSS-REFERENCE TO RELATED APPLICATIONS

This application claims priority from German patent application DE 10 2025 111 652.0 filed on Mar. 26, 2025. The entire content of this priority application is incorporated herein by reference.

### FIELD

This disclosure relates to a spring element for a temperature-dependent switching mechanism of a temperature-dependent switch. Furthermore, the present disclosure relates to a temperature-dependent switch in whose temperature-dependent switching mechanism the spring element is used. Furthermore, the present disclosure relates to a method of manufacturing a spring element for a temperature-dependent switching mechanism of a temperature-dependent switch.

Exemplary temperature-dependent switches are known from DE 10 2013 109 291 A1 and DE 10 2011 119 637 B4.

Such temperature-dependent switches serve in a manner known per se to monitor the temperature of a device. For this purpose, the switch is, for example, brought into thermal contact with the device to be protected via one of its outer surfaces, so that the temperature of the device to be protected influences the temperature of the switching mechanism arranged inside the switch.

The switch is typically connected electrically in series into the supply circuit of the device to be protected via connecting lines, so that below the response temperature of the switch, the supply current of the device to be protected flows through the switch.

The temperature-dependent switching mechanism arranged inside the switch provides the temperature-dependent switching behavior of the switch. In the closed switch state, the switching mechanism presses a movable contact part against at least one stationary contact, thus establishing an electrical connection between the two external terminals of the switch. In the open switch state, on the other hand, the switching mechanism keeps the movable contact part at a distance from the at least one stationary contact, so that the electrical connection between the two external terminals of the switch is disconnected.

The switching behavior, i.e., the switching between the closed switch state and the open switch state, occurs in a temperature-dependent manner. A bimetallic element is typically responsible for the temperature-dependent switching behavior of the switching mechanism, which in a known manner switches or snaps in a temperature-dependent manner in the manner of a hysteresis between two configurations, a low-temperature configuration or a low-temperature position and a high-temperature configuration or a high-temperature position.

If the temperature of the bimetallic element increases as a result of a temperature increase in the device to be protected above a defined temperature, which is referred to as the response temperature or switching temperature of the bimetallic element, the bimetallic element snaps from its low-temperature configuration to its high-temperature configuration, thereby causing a switching operation closed switch state to the open switch state or vice versa. Depending on the type of installation, the switch can be designed such that it is in the closed switch state below the response or switching temperature, which is referred to as “normally closed”, or instead is then in the open switch state, which is typically referred to as “normally open”.

In most of these temperature-dependent switches, a spring element is used in the temperature-dependent switching mechanism in addition to the bimetallic element. This spring element is typically referred to as a “temperature-independent spring element” because, unlike the bimetallic element, its behavior is independent of temperature.

This spring element typically serves to relieve the bimetallic element, both mechanically and electrically. In the closed switch state, it typically exerts the contact pressure by means of which the movable contact part is pressed against the at least one stationary contact. In addition, it conducts the electric current in the closed switch state. In the case of using such a spring element, the bimetallic element can thus be mounted mechanically force-free in the closed switch state and, moreover, does not have to serve as a current-carrying component. This has an enormously positive effect on the service life of the bimetallic element.

The spring element is often designed as a snap disc and has a convex-concave shape. The actuating force of the spring element is generally determined by the material thickness and the dome height of the spring element. In particular, the dome height or curvature of the spring element poses design challenges for the temperature-dependent switch, as this shape makes it virtually impossible to achieve a flat contact surface for the spring element, which serves as a current-carrying surface to the housing, both in the closed switch state and due to the movement during the switching operation. Usually, in the closed switch state, the spring element rests with its outer edge only along its peripheral edge on the inner side of the switch housing. This leads to a comparatively small current transfer area at the boundary between the switch housing and the spring element. This in turn limits the performance of the temperature-dependent switch.

In many cases, the bearing surface of the spring element on the bottom of the switch housing is therefore designed accordingly in order to ensure a constant and sufficiently large current transfer area. This is usually done by forming a circumferential bead in the switch housing, which is intended to ensure a defined support for the spring element. However, this requires a relatively complex manufacturing process for the switch housing, the parts of which typically have to be manufactured as turned parts.

In the switch disclosed in the aforementioned DE 10 2013 109 291 A1, the spring element is clamped in the switch housing along its circumferential outer edge to improve performance. Although this improves the electrical contact between the switch housing and the spring element and thus reduces the contact resistance, the clamping at the edge causes stresses within the spring element, which must be compensated for by complex stress-compensating sections incorporated into the spring element.

In the switch disclosed in the aforementioned DE 10 2011 119 637 B4, a part of the outer edge of the spring element is connected by a material bond to the lower part of the switch housing. This permanent galvanic connection of the spring element to the current-carrying lower part of the switch housing also ensures that the contact resistance between the spring element and the lower part of the switch housing is very low. However, the material-bonded attachment of the spring element to the switch housing requires an additional work step. Since such spring elements are very fragile, thin and extremely small components, welding or soldering is also a technical challenge. Moreover, such a material-bonded connection, which ensures a fixed clamping of the spring element, also induces unwanted stresses in the spring element.

### SUMMARY

It is an object to provide a spring element, a temperature-dependent switch having such a spring element, and a method of manufacturing the spring element, with which the above-mentioned disadvantages can be overcome or at least largely eliminated. In particular, it is an object to provide a spring element that can be manufactured as simply as possible, in a few work steps, can be inserted into the switch housing of the switch in a simple manner and in a manner as automated as possible during assembly, but nevertheless ensures the lowest possible contact resistance between the spring element and the switch housing, so that the performance of the switch can be increased.

According to a first aspect, a spring element for a temperature-dependent switching mechanism of a temperature-dependent switch is presented, comprising a central portion having a convexly curved upper side and a concavely curved lower side; and a plurality of support portions distributed circumferentially around the central portion, wherein each support portion extends from an outer edge of the central portion inwardly in a direction toward a central axis of the spring element, and wherein each support portion has a first side facing the lower side of the central portion.

In the spring element, the support portions are thus arranged, so to speak, underneath the central portion of the spring element and extend from the outer, circumferential edge of the central portion inwardly in the direction of the central axis of the spring element. The first side of the support portions, which can also be referred to as the upper side of the support portions, faces the lower side of the central portion, but is spaced apart from it.

This type of arrangement allows for the formation of comparatively large-area support portions on the spring element, which can nevertheless be “hidden” in a space-saving manner underneath the central portion. The ability to form the support portions with a comparatively large area allows the contact resistance between the switch housing and the spring element to be reduced, thereby increasing the performance of the switch.

At the same time, the inwardly directed support portions arranged under the central portion can ensure a mechanically stable stand of the spring element. The spring element can thus be loosely inserted into a temperature-dependent switch and does not have to be fixedly connected to the switch housing, as is the case, for example, with the switches known from DE 10 2013 109 291 A1 and DE 10 2011 119 637 B4. Complex special constructions inside the switch housing, such as the aforementioned circumferential bead, are also not required.

By “hiding” the support portions underneath the central portion of the spring element, the overall size of the spring element is not increased, or is increased only very slightly, compared to a circular-disc-shaped snap spring disc with a convex-concave shape (without support portions). At least the outer diameter of the spring element can remain the same, so that the spring element can also be used in the already provided switches, in which purely circular-disc-shaped snap spring discs were previously used, without further adaptations.

In addition, there are further advantages such as, for example, easier separation and magazineability, since the support portions also ensure that the spring elements do not stick to one another during bulk storage. With conventional, purely convex-concave shaped, lenticular spring elements, it is often the case that several spring elements stick together during bulk storage, which in particular can lead to complications during assembly or makes their separation difficult.

A further advantage resulting from the spring element is the possibility of being able to adapt the contact resistance to a desired value depending on the size selection of the support portions. Depending on the intended use, the spring element can thus be provided in different variants with support portions of different sizes. Depending on the desired level of contact resistance, a corresponding variant of the spring element can then be installed in the switch.

According to a second aspect, a temperature-dependent switch is presented, comprising two external terminals and a temperature-dependent switching mechanism configured to switch, depending on its temperature, between a closed switch state, in which an electrically conductive connection between the two external terminals is established, and an open switch state, in which the electrically conductive connection is disconnected. The temperature-dependent switching mechanism comprises a spring element comprising a central portion having a convexly curved upper side and a concavely curved lower side; and a plurality of support portions distributed circumferentially around the central portion, wherein each support portion extends from an outer edge of the central portion inwardly toward a central axis of the spring element, and wherein each support portion has a first side facing the lower side of the central portion.

Here, it is particularly preferred that the switching mechanism comprises a stationary contact and a movable contact part, wherein the spring element is operatively connected to the movable contact part such that it presses the movable contact part against the stationary contact in the closed switch state and/or keeps it spaced apart from the stationary contact in the open switch state.

According to a third aspect, a method of manufacturing a spring element for a temperature-dependent switching mechanism of a temperature-dependent switch, comprising the steps:
(i) punching the spring element from a metal sheet, the spring element including a central portion and a plurality of support portions distributed circumferentially around the central portion and projecting outwardly from the central portion;
(ii) forming the spring element to have a convexly curved upper side and a concavely curved lower side; and
(iii) bending the plurality of support portions such that each support portion extends inwardly toward a central axis of the spring element and such that a first side of each support portion faces the lower side of the central portion.

The spring element can thus be manufactured in a simple and cost-effective manner in just a few steps. The spring element is preferably a stamped part, whose convex-concave central portion is preferably produced by embossing and whose support portions are produced by forming or bending of initially still radially outwardly projecting portions inwardly in the direction of the central axis of the spring element, in order to arrange them as mentioned below the lower side of the central portion of the spring element, but spaced apart from this lower side (i.e. no direct contact between the first side of the support portions and the lower side of the central portion).

According to a refinement, the plurality of support portions each have a second side opposite the first side of the respective support portion and facing away from the underside of the central portion, wherein the second sides of the plurality of support portions each have a planar surface, wherein the planar surfaces of the plurality of support portions lie in a common planar plane.

In other words, the support portions are designed to be planar or flat on their lower side (here referred to as the “second side”), which faces away from the central portion of the spring element, wherein the individual lower sides of the support portions lie in a common plane.

As a result, the spring element can be placed on a flat surface, with the support portions forming a comparatively large bearing surface, by which the current-carrying capacity is increased and the contact resistance is reduced.

The plurality of support portions can each be connected to the central portion by a material bond or be integrally formed with the central portion.

In the first-mentioned case, the support portions can, for example, be welded or soldered to the central portion. However, since this requires additional work steps and also limits the mechanical stability of the spring element, an integral design of the support portions is preferred. The support portions are thus, in other words, preferably integrally or monolithically formed with the central portion.

According to a preferred refinement, the plurality of support portions are each integrally formed with the central portion and bent relative to the central portion.

According to the presented method, the support portions are thus punched out together from one piece with the central portion from a metal sheet and the support portions are then brought into the inventive shape or arrangement by forming.

According to a further refinement, the spring element comprises, for each support portion, a recess arranged at a transition location between the central portion and the respective support portion.

This material recess ensures that the support portions can be bent more easily with respect to the central portion, and specifically without wrinkling.

According to a further refinement, the plurality of support portions comprises at least three support portions.

For example, the spring element comprises exactly three support portions or exactly four support portions. This ensures a mechanically stable support of the spring element, which is preferably placed on the inner bottom surface of the switch housing.

According to a further refinement, the plurality of support portions each define a longitudinal axis oriented in a respective radial direction orthogonal to the central axis of the spring element.

According to this refinement, the support portions thus extend radially inward from the radially outer edge of the central portion. The respective longitudinal axis of the support portions, which preferably divides the respective support portion into two equal halves in the middle, thus coincides with the radial direction. This type of arrangement allows for the largest possible formation of the support portions without them overlapping. In addition, this type of orientation of the support portions ensures a very stable stand of the spring element when it is placed on the support portions.

According to a further refinement, each of the plurality of support portions comprises a free front edge, wherein an imaginary circle, which is tangential to the free front edges, has its center on the central axis of the spring element and is oriented in a plane orthogonal to the central axis, has a diameter that is smaller than a diameter of the central portion measured in the same plane.

In other words, all support portions according to this refinement extend in a radial direction and are formed to be of equal length. The diameter of the described imaginary circle is preferably less than 90%, particularly preferably less than 80%, of the diameter of the central portion. The diameter of the central portion corresponds to the outer diameter of the spring element.

According to a further refinement, the central portion is substantially disc-shaped in plan view.

According to a further refinement, the central portion comprises, at its center, a hole or a contact element protruding from the upper side.

The aforementioned second alternative corresponds to a direct attachment of the movable contact part to the spring element. According to the first-mentioned variant, the movable contact part is guided through the hole in the central portion in the assembled state of the temperature-dependent switch. In this case, in the assembled state of the switch, the spring element with its central hole can be slipped over the movable contact part loosely, non-detachably, but with play, or be fixedly connected to the movable contact part.

According to a further refinement, the spring element is designed to be rotationally symmetrical with respect to the central axis.

This ensures a uniform force distribution. In addition, a degree of freedom (rotation about the central axis of the spring element) is intentionally left open during assembly.

According to a further refinement, at least part of the spring element is made of steel or copper-beryllium.

According to a further refinement, the plurality of support portions are coated on their respective second sides with a metal coating having a higher electrical conductivity than steel or copper-beryllium.

This refinement has the particular advantage that the conductivity of the current transfer surfaces of the spring element is additionally increased by the additional coating on the lower side of the support portions. This further reduces the contact resistance, whereby an additional performance increase of the switch can be achieved. A particular advantage of this refinement arises in comparison to conventional spring elements which are coated as a whole with a metal layer of higher electrical conductivity. Typically, silver is used for this purpose. In the present case, however, not the entire spring element needs to be coated, but it is sufficient to coat only the lower sides, i.e., the second sides of the support portions, with silver. It has been shown that this can save 40% or more of the silver consumption. This leads, comprehensibly, to enormous cost advantages.

It is understood that the features mentioned above and those yet to be explained below can be used not only in the combination indicated in each case, but also in other combinations or in isolation, without departing from the spirit and scope of the present disclosure.

### BRIEF DESCRIPTION OF THE DRAWINGS

FIG. 1 shows a first embodiment of a spring element in a plan view from above;

FIG. 2 shows a sectional view of the spring element shown in FIG. 1;

FIG. 3 shows a sectional view of the spring element according to a second embodiment;

FIG. 4 shows a third embodiment of the spring element in a plan view from above;

FIG. 5 shows the spring element shown in FIG. 4 in a plan view from above in a state during manufacture, before the last manufacturing step;

FIG. 6 shows a schematic sectional view of an embodiment of a switch, wherein the switch is in the closed switch state; and

FIG. 7 shows a schematic sectional view of the switch shown in FIG. 6, wherein the switch is in the open switch state.

### DESCRIPTION OF PREFERRED EMBODIMENTS

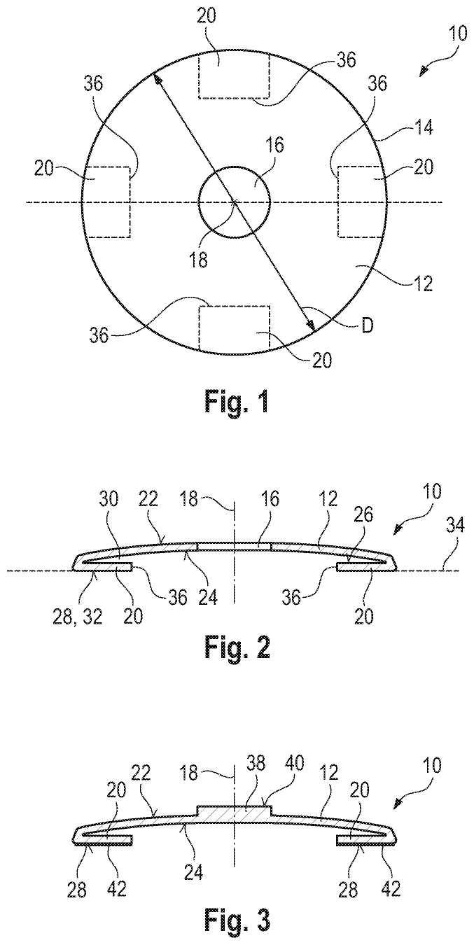

FIGS. 1 and 2 show a first embodiment of the spring element. The spring element is designated therein in its entirety by the reference numeral 10. FIG. 1 shows the spring element 10 in a plan view from above. FIG. 2 shows the spring element 10 in a sectional view.

The spring element 10 is typically made of metal. The spring element 10 is particularly preferably made of steel or copper-beryllium.

In the first embodiment shown in FIG. 1, the spring element 10 has a disc-shaped outer contour in plan view from above. It comprises a central portion 12, which forms the center region of the spring element 10. This central portion 12 is disc-shaped or annular in a plan view from above. It comprises a radially outer edge 14, which lies on a circular line. This disc shape is, however, not absolutely necessary. The outer edge 14 of the central portion 12 of the spring element 10 can just as well lie on an oval line or a rectangular line.

In the center, the spring element 10 comprises a hole 16 according to the embodiment shown in FIG. 1. This hole 16 surrounds a central axis 18, which at the same time forms a symmetry axis of the spring element 10.

In addition to the central portion 12, the spring element in the embodiment shown here comprises four support portions 20, which are indicated by dashed lines in FIG. 1, as they are not actually visible plan view from above shown in FIG. 1. The support portions 20 are arranged below the central portion 12. This is particularly evident when viewed in conjunction with FIG. 2.

The support portions 20 are distributed in a circumferential direction and each extend from the outer edge 14 of the central portion 12 inwardly in the direction of the central axis 18. They serve as support elements, with the help of which the spring element 10 can be supported on a planar substrate.

The central portion 12 is convex-concavely curved. It has a convexly curved upper side 22 and a concavely curved lower side 24, which is opposite the upper side 22 and faces away from it. In cross-section, the upper side 22 and the lower side 24 of the central portion 12 are each arcuately curved. It is particularly preferred that the upper side 22 and the lower side 24 of the central portion 12 run parallel to each other, so that the spring element 10 has a constant wall thickness in the region of the central portion 12.

The support portions 20, on the other hand, are planar or flat portions which are straight in cross-section (see FIG. 2). Their upper side, which is referred to here as the “first side” 26, faces the concavely curved lower side 24 of the central portion 12, but is spaced apart from it. Thus, a kind of gap is formed between the lower side 24 of the central portion 12 and the first side 26 of the support portions 20. This gap is indicated in FIG. 2 by the reference numeral 30.

The lower side of the support portions 20, which is referred to here as the “second side” 28, is opposite the first side 26 and faces away from it as well as from the lower side 24 of the central portion 12.

The second side 28 of the support portions 20 preferably runs parallel to the first side 26 of the support portions 20. Furthermore, it is preferred that the support portions 20 each comprise a planar surface on their respective second side 28. This planar surface is designated in FIG. 2 by the reference numeral 32 and is identical to the second side 28 of the support portions 20. The planar surface 32 forms, in the embodiment shown here, the entire second side 28 of the support portions 20. However, this does not necessarily have to be the case. For example, only a part of the second side 28 of the support portions 20 forming the lower side can be designed to be planar, so that then only this planar part forms the said planar surface 32 of the respective support portion 20.

Irrespective of this, it is preferred that the individual planar surfaces 32, which are formed on the second sides 28 of the support portions 20, lie in a common planar plane. This planar plane 34, which can also be referred to as the support plane of the spring element 10, is indicated in FIG. 2 by the dashed line 34. The spring element 10 can thus be placed flat on a planar or flat substrate and then has planar contact with the substrate with all four support portions 20.

The support portions 20 are integrally formed with the central portion 12 of the spring element 10 in the embodiment shown here. They are, as will be explained further below, bent relative to the central portion 12. More precisely, they are bent inwardly in the direction of the central axis 18 of the spring element, so that the support portions 20 are each arranged underneath the central portion 12. The free front edges 36 of the support portions 20 are thus facing the central axis 18. An imaginary circle, which is tangential to these free front edges 36 of the support portions 20, has its center on the central axis 18 and is oriented in a plane orthogonal to the central axis 18, has a diameter that is smaller than the diameter D of the central portion 12, which corresponds to the diameter D of the spring element 10. This imaginary circle is not explicitly shown in FIG. 1 for the sake of clarity. However, one can imagine this imaginary circle in the plane of the drawing as a circle concentric with the outer edge 14, which is tangential, as mentioned, to the front edges 36 of the support portions 20.

FIG. 3 shows a second embodiment of the spring element 10. This second embodiment differs from the first embodiment of the spring element 10 shown in FIGS. 1 and 2 essentially in that a contact element 38 is provided instead of a centrally arranged hole 16. This contact element 38 is arranged centrally on the central portion 12.

In the embodiment shown in FIG. 3, the contact element 38 is formed integrally or in one piece with the central portion 12 of the spring element 10. However, it can in principle also be connected to it by a material bond.

The contact element 38 has on its upper side a contact surface 40 which serves for electrical contacting. With this contact surface 40, the spring element 10, as will be shown in detail below, rests against a stationary counter-contact in the closed switch state. The contact element 38 therefore projects upward from the upper side 22 of the central portion 12 of the spring element 10.

In the embodiment shown in FIG. 2, in which a centrally arranged hole 16 is provided instead, a separate contact element, which may have a similar shape to the contact element 38, is guided through the hole 16.

A further difference of the second embodiment shown in FIG. 3 is that the support portions 20 are provided with a coating on their respective second side 28. This coating has a metal coating 42 which, in comparison to the material from which the rest of the spring element 10 is made (e.g. steel or copper-beryllium), has a higher electrical conductivity. This allows the contact resistance of the spring element 10 to be reduced. It is understood that this metal coating 42 can also be arranged on the spring element 10 according to the first embodiment shown in FIGS. 1 and 2.

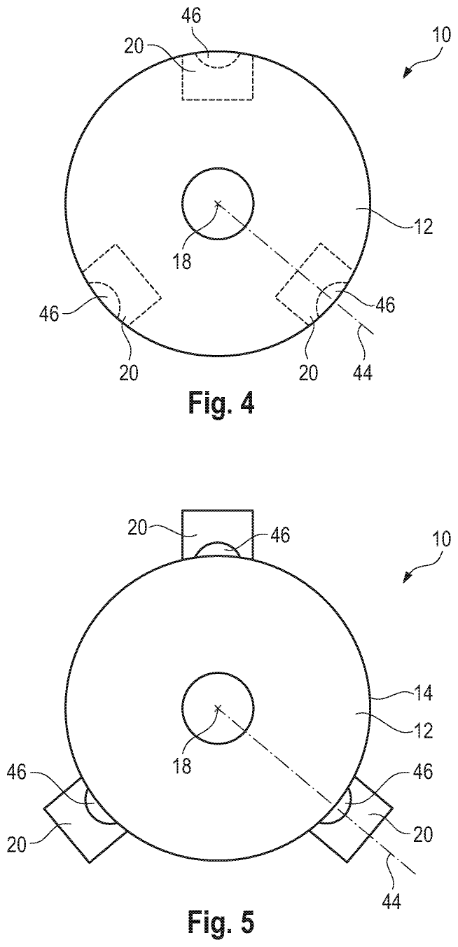

FIG. 4 shows a third embodiment of the spring element 10 in a plan view from above. In contrast to the first embodiment shown in FIG. 1, the spring element 10 according to the third embodiment shown in FIG. 4 comprises “only” three support portions 20, which are arranged offset from each other by an angle of 120°. These support portions 20 also each extend in a radial direction. More precisely, the longitudinal axes 44 of the individual support portions 20 extend in the radial direction of the spring element 10. By the longitudinal axes 44 are meant the axes of the respective support portions 20, which divide the respective support portion into two equal halves and each intersect the central axis 18 of the spring element 10 perpendicularly. One of these axes is indicated in FIG. 4 as a dashed line 44.

According to the third embodiment shown in FIG. 4, the spring element 10 comprises one recess 46 per support portion 20. In the embodiment shown here, a total of three recesses 46 are provided, which are indicated in FIG. 4 by a dashed line. These recesses 46 are each arranged at a transition location between the central portion 12 and the respective support portion 20. The recesses 46 are intended in particular to facilitate the manufacture of the spring element 10.

The recesses 46 make it easier to bend the support portions 20 into their desired final arrangement. During the manufacture of the spring element 10, it is first punched out of a metal sheet. In particular, a contour is punched out of the metal sheet that corresponds to the contour shown in FIG. 5. The support portions then initially project in a radial direction from the outer edge 14 of the central portion 12 radially outwards. They each form a kind of flange tab.

In the next production step, the spring element 10, in particular the central portion 12 is embossed into the desired convex-concave shape. In the last work step, the support portions 20 are then bent inwards. In this work step, the recesses 46 prevent wrinkling at the edge 14 of the central portion 12. The recesses 46 thus facilitate the bending of the support portions 20 inwards.

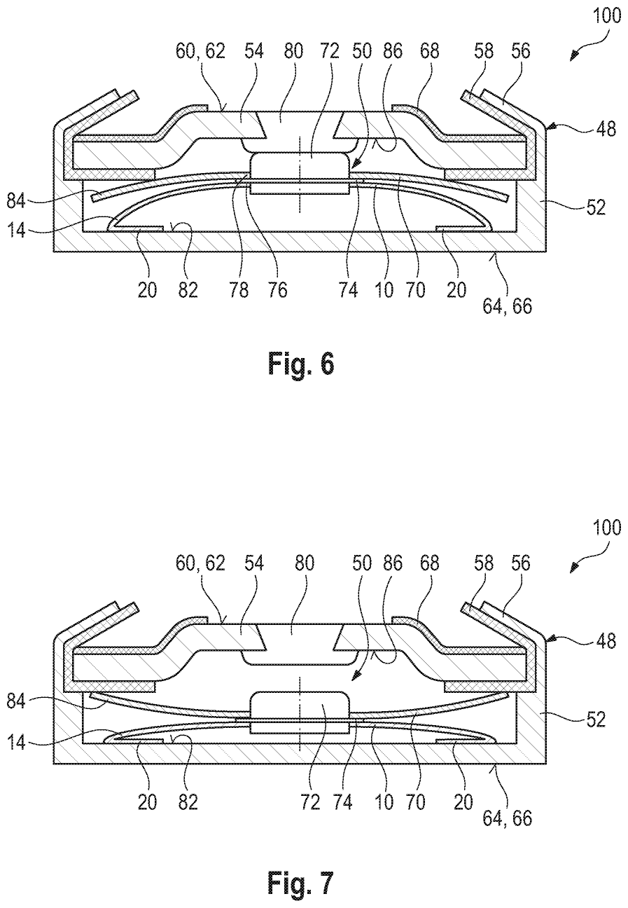

FIGS. 6 and 7 show a possible embodiment of a temperature-dependent switch 100 in which the spring element 10 is used. FIG. 6 shows the closed switch state of the switch 100. FIG. 7 shows the open switch state of the switch 100.

It is understood that the switch 100 shown in FIGS. 6 and 7 is only one of various possible examples of such a temperature-dependent switch in which the spring element 10 can be used. The spring element 10 can in principle also be used in various other temperature-dependent switches which are structurally different from the switch 100 shown in FIGS. 6 and 7. The switch 100 shown in FIGS. 6 and 7 is described below, however, by way of example as a possible temperature-dependent switch in order to explain the basic structure and function of such a temperature-dependent switch.

The switch 100 comprises a switch housing 48, in the interior of which a temperature-dependent switching mechanism 50 is arranged. The switch housing 48 includes a pot-shaped lower part 52 and a cover part 54, which is held on the lower part 52 by a bent or flanged upper edge 56.

Both the lower part 52 and the cover part 54 are made of an electrically conductive material, preferably metal, in the embodiment of the switch 100 shown in FIGS. 6 and 7. An insulating film 58 is arranged between the lower part 52 and the cover part 54. The insulating film 58 provides for electrical insulation of the lower part 52 with respect to the cover part 54. The insulating film 58 also provides a mechanical seal, which prevents liquids or contaminants from entering the interior of the switch housing 48 from the outside.

Since the lower part 52 and the cover part 54 in this example are each made of electrically conductive material, thermal contact with a device to be protected can be established via their outer surfaces. The outer surfaces also serve as the electrical connection of the switch 100. Thus, for example, the outer surface 60 of the cover part 54 can function as a first electrical external terminal 62 and the outer side 64 of the lower part 52 can function as a second external terminal 66.

A further insulation layer 68 is arranged on the outside of the cover part 54.

The switching mechanism 50 is clamped between the lower part 52 and the cover part 54. The switching mechanism 50 comprises, in addition to the spring element 10, a bimetallic element 70 and a movable contact part 72. The movable contact part 72 can be the contact element 38 shown in FIG. 3, which is integrally formed with the spring element 10. In the embodiment shown here, the movable contact part 72 is a separate contact part which is inserted into the central hole 16 of the spring element 10. The bimetallic element 70 is also provided with a central hole and is slipped over this movable contact part 72 from above.

The movable contact part 72 comprises a circumferential, disc-shaped collar 74, on which the spring element 10 rests with its inner edge 76 from below and the bimetallic element 70 rests with its inner edge 78 from above.

In the closed switch state of the switch 100 shown in FIG. 6, the spring element 10 presses the movable contact part 72 from below against a stationary counter-contact 80 arranged on the cover part 54. This stationary counter-contact 80 is often also referred to as the stationary contact 80 of the switch 100. Here, the spring element 10 is supported with the bearing surfaces provided on its respective second sides 28 on the inner bottom surface 82 of the switch lower part 52.

The bimetallic element 70 rests in this switch state of the switch 100 with its inner edge 78 preferably freely on the collar 74 of the movable contact part 72 from above. The outer, circumferential edge 84 of the bimetallic element 70 hangs freely into the interior of the housing 48. The bimetallic element 70 is thus mounted in the closed switch state of the switch 100 almost force-free in the switch housing 48, without being firmly clamped therein.

In the closed switch state of switch 100 shown in FIG. 6, the temperature-dependent switching mechanism 50 establishes an electrically conductive connection between the two external terminals 62, 66 of switch 100 by pressing the movable contact part 72 against the stationary contact 80. The contact pressure with which the movable contact part 72 is pressed against the stationary contact part 80 in the closed switch state of the switch 100 is effected by the spring element 10.

If the temperature of the device to be protected and thus the temperature of the switch 100 and of the bimetallic element 70 arranged therein now rises to the switching or response temperature of the bimetallic element 70 or above, the bimetallic element 70 snaps from its convex low-temperature configuration shown in FIG. 6 into its concave high-temperature configuration shown in FIG. 7. In this snapping process, the bimetallic element 70 is supported with its outer edge 84 on the lower side 86 of the cover part 54 and presses with its inner edge 78 the movable contact part 72 downwards. As a result, the movable contact part 72 is lifted off the stationary contact 80. As a result, the spring element 10 simultaneously bends downwards at its center and is compressed along its height or along its central axis 18. The previously established electrical connection between the two external terminals 62, 66 of the switch 100 via the switching mechanism 50 is thus interrupted.

The temperature-dependent switching mechanism 50 of the switch 100 is thus configured to establish or interrupt the electrically conductive connection between the two external terminals 62, 66 in a temperature-dependent manner.

Depending on the desired design, the temperature-dependent switching mechanism 50 can be configured either as explained previously, namely that the switching mechanism 50 assumes the closed switch state shown in FIG. 6 below the switching temperature of the bimetallic element 70 and assumes the open switch state shown in FIG. 7 above the switching temperature, or vice versa. In the first case, the switch is referred to as having a “normally closed” configuration. In the second case, the switch is referred to as having a “normally open” configuration.

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A spring element for a temperature-dependent switching mechanism of a temperature-dependent switch, the spring element comprising:
a central portion having a convexly curved upper side and a concavely curved lower side; and
a plurality of support portions distributed circumferentially around the central portion,
wherein each support portion extends from an outer edge of the central portion inwardly in a direction toward a central axis of the spring element, and each support portion has a first side facing the lower side of the central portion.

2. The spring element of claim 1, wherein each support portion further has a second side opposite the first side, the second side faces away from the lower side of the central portion, each second side comprises a planar surface, and the planar surfaces of the plurality of support portions lie in a common plane.

3. The spring element of claim 1, wherein each support portion is connected to the central portion by a material bond or is integrally formed with the central portion.

4. The spring element of claim 1, wherein each support portion is integrally formed with the central portion and is bent relative to the central portion.

5. The spring element of claim 1, wherein the spring element is made of an electrically conductive material.

6. The spring element of claim 1, wherein the spring element is made of metal.

7. The spring element of claim 1, wherein, for each support portion, the spring element comprises a recess located at a transition between the central portion and the respective support portion.

8. The spring element of claim 1, wherein the plurality of support portions include at least three support portions.

9. The spring element of claim 1, wherein each support portion defines a longitudinal axis oriented in a radial direction orthogonal to the central axis of the spring element.

10. The spring element of claim 1, wherein each support portion comprises a radially inner edge located closer to the central axis of the spring element than the outer edge of the central portion, the radially inner edges collectively define a circle having a center on the central axis of the spring element, the circle lies in a plane orthogonal to the central axis, and the circle has a diameter smaller than a diameter of the central portion measured in the same plane.

11. The spring element of claim 1, wherein the outer edge of the central portion is circular.

12. The spring element of claim 1, wherein the central portion comprises, at a center thereof, a hole or a contact element protruding from the upper side.

13. The spring element of claim 1, wherein at least a portion of the spring element is made of steel or copper-beryllium.

14. The spring element of claim 1, wherein each support portion has a second side opposite the first side, the second side facing away from the lower side of the central portion, at least a portion of the spring element is made of an electrically conductive material, and the second sides of the support portions are coated with a metal coating having a higher electrical conductivity than the electrically conductive material.

15. A temperature-dependent switch, comprising:
two external terminals; and
a temperature-dependent switching mechanism configured to switch, depending on its temperature, between a closed switch state, in which an electrically conductive connection between the two external terminals is established, and an open switch state, in which the electrically conductive connection is disconnected,
wherein the temperature-dependent switching mechanism comprises a spring element comprising:
a central portion having a convexly curved upper side and a concavely curved lower side; and
a plurality of support portions distributed circumferentially around the central portion,
wherein each support portion extends from an outer edge of the central portion inwardly toward a central axis of the spring element, and each support portion has a first side facing the lower side of the central portion.

16. The temperature-dependent switch of claim 15, wherein the switching mechanism comprises a stationary contact and a movable contact part, the spring element is operatively connected to the movable contact part to press the movable contact part against the stationary contact in the closed switch state and/or to keep the movable contact part spaced apart from the stationary contact in the open switch state.

17. A method of manufacturing a spring element for a temperature-dependent switching mechanism of a temperature-dependent switch, the method comprising the steps of:
punching the spring element from a metal sheet, the spring element including a central portion and a plurality of support portions distributed circumferentially around the central portion and projecting outwardly from the central portion;
forming the spring element to have a convexly curved upper side and a concavely curved lower side; and
bending the plurality of support portions such that each support portion extends inwardly toward a central axis of the spring element and such that a first side of each support portion faces the lower side of the central portion.
